(19) United States
(12) Patent Application Publication
(10) Pub. No.: US 2025/0109161 A1
(43) Pub. Date: Apr. 3, 2025

(54) HEME, COMPOSITIONS AND METHOD OF SYNTHESIS THEREOF

(71) Applicant: NATIONAL UNIVERSITY OF SINGAPORE, Queenstown (SG)

(72) Inventors: Tai Wei David LEONG, Queenstown (SG); Wee Han ANG, Queenstown (SG); Lai Peng LEONG, Queenstown (SG); Jing Rui THAM, Queenstown (SG)

(21) Appl. No.: 18/714,861

(22) PCT Filed: Nov. 28, 2022
(86) PCT No.: PCT/SG2022/050864

§ 371 Date: May 30, 2024

(30) Foreign Application Priority Data
Nov. 30, 2021 (SG) 10202113335T

(51) Int. Cl. C07F 15/02; A23L 29/00; A23L 33/105; A23L 33/175

(52) U.S. Cl. CPC C07F 15/025; A23L 29/00; A23L 33/105; A23L 33/175

(57) ABSTRACT

The present disclosure concerns heme and methods of synthesis thereof. The present disclosure also concerns to compositions and products thereof. The heme composition comprises heme at about 0.05% w/w to about 1% w/w relative to the heme composition and an antioxidant at about 0.25% w/w to about 5% w/w relative to the heme composition, wherein the heme is derived from protoporphyrin IX extracted from a plant, algal, bacterial and/or animal source.

### TECHNICAL FIELD

The present invention relates, in general terms, to heme and methods of synthesis thereof. The present invention also relates to compositions and products thereof.

### BACKGROUND

Recently, new forms of vegetarian food are re-marketed as plant-based meat which asserts to have similar taste, aroma, texture and appearance as animal meat. The growing popularity of the vegan diet coupled with perceptions of high quality and healthier plant-based meat that tastes like meat is attracting even meat eaters and driving up demand. Despite the current optimism, plant-based meat in the US currently only corners less than 1% market share of the entire US meat industry and struggles to replicate meat products beyond products such as burgers, nuggets and ground beef within the US cuisine genre.

Despite the currently minute meat market share, companies like Impossible™ Foods (˜800 million USD investments) and Beyond Meat™ (30 Jan. 2020 market capitalization: ˜7 billion USD) are riding high on this fast-expanding wave of plant based meat that promises to satisfy the palates of animal meat eaters. The well-publicized “secret” ingredient in Impossible™ Foods' Impossible Burger is heme. Heme is an important component in blood and when mixed into a soy-based food product and cooked, as asserted by Impossible™ Foods, can produce the taste, aroma, texture and appearance of cooked beef. Impossible™ Foods' heme is produced by genetically modified yeast that produces soy-leghemoglobin. By mixing heme with soy protein, they were able to recreate the beef taste of real beef patty. Currently, Impossible™ Foods' does not sell the heme additive on its own but sells the whole plant-based meat product. By doing so, they were able to control the consumption of their burger patty experience but in the same stroke, they have also limited the possible food applications of heme to just the patty. This also creates an entry barrier for future plant-based meat companies that uses plant-derived heme.

It would be desirable to overcome or ameliorate at least one of the above-described problems.

### SUMMARY

The present invention provides a heme composition, comprising:
a) heme at about 0.05% w/w to about 1% w/w relative to the heme composition; and
b) an antioxidant at about 0.25% w/w to about 5% w/w relative to the heme composition;
   wherein the heme is derived from protoporphyrin IX extracted from a plant, algal, bacterial and/or animal source.

With the use of food safe solvents and reagents, the heme composition is safe for consumption and can be added into alternative food products to create a taste profile that is more meat like.

In some embodiments, the plant, algal, bacterial and/or animal source is selected from photosynthetic plant, photosynthetic algae, non-photosynthetic algae, cyanobacteria organism containing chlorophyll, animal blood, eggshell which is derived from eggs of Gallus gallus domesticus (Chicken), Anas platyrhynchos domesticus (Duck), Coturnix genus (Quails), or a combination thereof.

In some embodiments, the animal source is a non-blood source.

In some embodiments, the antioxidant is selected from DL-α-tocopherol, butylated hydroxyanisole (BHA), butylated hydroxytoluene, propyl gallate, trihydroxybutyrophenon (THBP), nordihydroguaiaretic acid, t-butylhydroquinone (TBHQ), dilauryl thiodiopropionate, ascorbic acid, sodium ascorbate, potassium ascorbate, erythorbic acid, ascorbyl palmitate, ascorbyl acetal, or a combination thereof.

In some embodiments, the heme composition further comprises an amino acid at about 2% w/w to about 40% w/w relative to the heme composition.

In some embodiments, the amino acid is selected from D-amino acid, L-amino acid, DL-amino acid or their respective dipeptide, tripeptide, oligopeptide and polypeptide thereof.

In some embodiments, the heme composition further comprises a flavour enhancer at about 2% w/w to about 45% w/w relative to the heme composition.

In some embodiments, the flavour enhancer is selected from animal-based and plant-based lipids such as short (5 carbon atoms or less), medium (6 to 12 carbon atoms), long (13 to 21 carbon atoms) and very long-chained (22 carbon atoms or more) saturated and/or unsaturated fatty acids either in their free fatty acid forms and/or contained within a triglyceride or phospholipid molecule, nucleoside, nucleotide, vitamin, protein hydrolysate from animal, plant, fungal, bacterial and/or in vitro origin, lecithin, or a combination thereof.

In some embodiments, the heme composition further comprises a sugar at about 1% w/w to about 20% w/w relative to the heme composition.

In some embodiments, the heme composition further comprises sodium chloride at about 0.5% w/w to about 15% w/w relative to the heme composition.

In some embodiments, the heme composition further comprises a solvent, the solvent comprising:
a) water at about 40% w/w to about 60% w/w relative to solvent;
b) oil at about 17.5% w/w to about 35% w/w relative to solvent; and
c) a humectant at about 5% w/w to about 25% w/w relative to solvent.

In some embodiments, the oil is selected from coconut oil, algal oil, corn oil, soybean oil, palm fruit oil, palm kernel oil, safflower oil, flaxseed oil, rice bran oil, cottonseed oil, sunflower oil, canola oil, olive oil, or a combination thereof.

In some embodiments, the humectant is selected from lactic acid, acetic acid, glycerol, or a combination thereof.

In some embodiments, the solvent further comprises pH modulator at about 0.75% w/w to about 3% w/w relative to solvent.

In some embodiments, the pH modulator is selected from acids such as hydrochloric acid, hydrobromic acid, hydroiodic acid, glacial acetic acid or formic acid, or a combination thereof, or bases such as hydroxides, carbonates and bicarbonates of lithium, sodium, potassium, and ammonium hydroxide, or a combination thereof.

In some embodiments, the heme composition is characterised by a presence of hemin, hematin, Protoporphyrinogen IX, Coporphyrinogen III, Uroporphyrinogen III, Coporphyrin, Uroporphyrin, pentacarboxylic porphyrin, or a combination thereof.

In some embodiments, the heme composition is a biphasic mixture, oil-in-water or water-in-oil emulsified liquid system, semi-solid gel, suspension, monophasic liquid or solid.

In some embodiments, the heme comprises protoporphyrin IX and an iron salt, wherein the heme is generated when heat is applied to the heme composition.

The present invention also provides a heme food product, comprising:
a) heme composition as disclosed herein at about 9% w/w to about 11% w/w relative to the heme food product; and
b) an alternative protein at about 15% w/w to about 40% w/w relative to the heme food product;
   wherein heme is about 0.002% w/w to about 0.05% w/w relative to the heme food product.

In some embodiments, the alternative protein is derived from a source selected from plant, insect, fungus, bacteria, in vitro cultured animal cells, or a combination thereof.

In some embodiments, the alternative protein is derived from a plant source selected from soy, pea, wheat, lentil, lupin, vetch, chickpea, cowpea, pigeon pea, adzuki bean, bambara bean, black bean, fava bean, kidney bean, lima bean, long bean, mung bean, navy bean, tepary bean, velvet bean, yam bean, oat, rice, quinoa, buckwheat, amaranth, camelina seed, hemp seed, pumpkin seed, rapeseed, sunflower seed, peanut, cashew nut, potato, jackfruit, duckweed, sweet potato, tapioca or a combination thereof.

In some embodiments, the alternative protein is derived from a fungus source selected from Aspergillus spp., Agrocybe spp. (Poplar mushrooms), Fusarium spp. (Microfungus), Monascus spp., Mucor spp., Neurospora spp., Komagataella spp., Rhizopus spp., Saccharomyces spp., Zygosaccharomyces spp., Agaricus bisporus (button mushroom), Flammulina filiformis (enokitake), Grifola frondosa (maitake), Lentinula edodes (shiitake), Lyophyllum shimeji (hon-shimeji), Morchella spp. (morels), Pleurotus spp. (oyster mushrooms), Volvariella volvacea (straw mushroom), or a combination thereof.

In some embodiments, the alternative protein is derived from an insect source selected from the Insecta Class.

In some embodiments, the heme food product further comprises a vegetable oil at about 5% w/w to about 15% w/w relative to the heme food product.

In some embodiments, the heme food product further comprises a food flavouring at about 2.5% w/w to about 25% w/w relative to the heme food product.

In some embodiments, the heme food product further comprises a stabiliser at about 1% w/w to about 4% w/w relative to the heme food product.

In some embodiments, the heme food product further comprises a food colouring at about 0.035% w/w to about 0.5% w/w relative to the heme food product.

The present invention also provides a method of synthesising heme, comprising:
a) extracting crude protoporphyrin IX from a plant, algal, bacterial and/or animal source using an extraction solvent;
b) purifying the crude protoporphyrin IX in order to form purified protoporphyrin IX;
c) metalating the purified protoporphyrin IX with an iron salt, base and under inert conditions in order to form heme;
   wherein the extraction solvent is a mixture of an acid and an organic solvent.

In some embodiments, the plant, algal, bacterial and/or animal source is eggshell.

In some embodiments, the acid in the extraction solvent is an inorganic acid, organic acid, or a combination thereof.

In some embodiments, the acid is selected from hydrochloric acid, hydrobromic acid, hydroiodic acid, sulphuric acid, nitric acid, glacial acetic acid, formic acid, or a combination thereof.

In some embodiments, the organic solvent in the extraction solvent is a polar solvent.

In some embodiments, the organic solvent is selected from acetone, methanol, ethanol, isopropanol, ethyl acetate, propyl acetate, butyl acetate, alkyl ester, or a combination thereof.

In some embodiments, the extraction step further comprises stirring the plant and/or animal source in the extraction solvent at about 15° C. to about 60° C.

In some embodiments, the extraction step further comprises stirring the plant and/or animal source in the extraction solvent at about 600 mmHg to about 900 mmHg.

In some embodiments, the extraction step further comprises filtering the plant and/or animal source in the extraction solvent in order to obtain the crude protoporphyrin IX in a filtrate.

In some embodiments, the extraction step further comprises basifying the filtrate with a base in order to precipitate the crude protoporphyrin IX as a solid.

In some embodiments, the base is an inorganic base.

In some embodiments, the base is selected from lithium hydroxide, sodium hydroxide, potassium hydroxide, ammonium hydroxide, or a combination thereof.

In some embodiments, the purification step comprises the dissolving the crude protoporphyrin IX in a polar solvent, filtering the crude protoporphyrin IX in the polar solvent in order to obtain a filtrate and removing the polar solvent from the filtrate.

In some embodiments, the polar solvent is a polar aprotic solvent.

In some embodiments, the polar solvent is selected from dimethyl sulfoxide, N,N-dimethylformamide, or a combination thereof.

In some embodiments, the iron salt is selected from iron(II) chloride, iron(III) chloride, iron(II) bromide, iron(III) bromide, iron(II) iodide, iron(III) iodide, iron(II) sulphate, iron(III) sulphate, iron(II) nitrate, iron(III) nitrate, iron(II) fumarate, iron(III) fumarate, iron(II) gluconate, iron(III) gluconate, their hydrates thereof, or a combination thereof.

In some embodiments, the base is selected from metal hydroxide, metal bicarbonate, metal carbonate, metal oxide, or a combination thereof.

In some embodiments, the metal is selected from sodium, potassium, magnesium, calcium, or a combination thereof.

In some embodiments, the metalation step is performed in the presence of a solvent.

In some embodiments, the solvent is selected from formic acid, acetic acid, acetone, ethanol, dimethyl sulfoxide, N,N-dimethylformamide, or a combination thereof.

In some embodiments, the inert condition is inert gas selected from helium, argon, nitrogen, carbon dioxide, or a combination thereof.

In some embodiments, the metalation step is performed at a temperature at about 50° C. to about 190° C.

In some embodiments, the metalation step is performed for about 4 h to about 24 h.

In some embodiments, the metalation step further comprises acidifying the heme in order to precipitate hemin or hematin as a solid.

In some embodiments, the acid is selected from hydrochloric acid, hydrobromic acid, hydroiodic acid, sulphuric acid, nitric acid, or a combination thereof.

### BRIEF DESCRIPTION OF THE DRAWINGS

Embodiments of the present invention will now be described, by way of non-limiting example, with reference to the drawings in which:

FIG. 1 is a schematic drawing of protoporphyrin IX (PPY9) conversion to Heme.

FIG. 2 shows a process of extracting and purifying PPY9 from eggshells.

FIG. 3 shows a synthesis route to prepare Heme from PPY9 using food grade materials.

FIG. 4 shows a Heme solution made by dissolving heme in aqueous-hydrophobic medium.

FIG. 5 shows a colour transition of Heme Solution before (left) and after (right) heating at 160° C. for 3 minutes.

FIG. 6 shows an uncooked plant based meat patty infused with Heme solution.

FIG. 7 shows cooked plant based meat patty infused with Heme solution.

FIG. 8 shows relative concentrations of hexanal detected in inorganic iron (control) and heme flavour mixtures.

FIG. 9 shows a PCA plot of the volatile compositions for all flavour mixtures.

FIG. 10 shows a comparison of aromatic profiles of Heme Iron (at different concentration levels) and Control samples.

FIG. 11 shows a comparison of aroma profiles of Heme Iron, Inorganic Iron and Control (No Iron) samples, as detected by semi-trained panellists.

### DETAILED DESCRIPTION

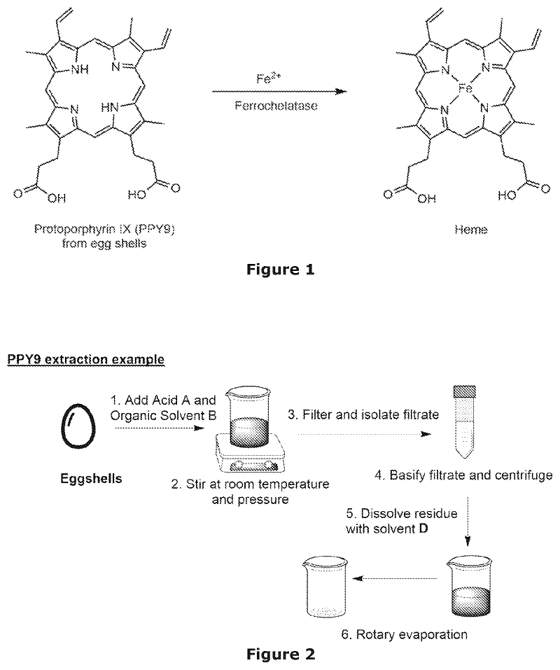

The present invention is predicated on the understanding that heme can be synthesised from other food or non-food sources. For example, a non-genetically modified organism (non-GMO)-derived alternative can be used to produce food grade heme. In particular, protoporphyrin IX (PPY9) is the precursor molecule to heme (FIG. 1). The difference between PPY9 and Heme is the iron ion within the porphyrin ring. The reactions that converts PPY9 to heme involves complexing an iron ion in the center of the porphyrin ring. These reactions occur naturally in many types of cells through an enzyme called ferrochelatase. As heme is also present in the human body, the genetic machinery to produce heme is hotwired into our mammalian genomes so this PPY9 conversion to heme is 100% natural and does not require any genetic modification. This advantageously alleviates concerns that GMO can negatively affect human health, which results from differences in nutritional content, allergic response, or undesired side effects such as toxicity, organ damage, or gene transfer.

PPY9 can be found in plants, algae, bacteria and animals. As an example, the PPY9 pigment was extracted from brown eggshells. The PPY9 is then reacted to form heme. This heme can be used in many alternative protein products meant to improve food sufficiency. The addition of heme into food is useful not just to improve the flavour of these meat products but also to improve iron availability in our diet as the population moves towards a lower consumption of meat.

While heme can be chemically synthesised from its appropriate subunits, it is impractical, expensive, and difficult, due to the need to install different functional groups at specific locations on the porphyrin ring. This synthetic difficulty would result in low yields and complicated purification procedures, driving up production costs.

As used herein, “heme” or “heme b” or “haem” refers to the metalloporphyrin complex molecule whereby an iron cation (Fe²⁺ or Fe³⁺) is coordinated to a protoporphyrin IX molecular scaffold, and has an identical structure to the heme B prosthetic group found in haemoglobin or myoglobin.

Hemin is a specific form of heme in which protoporphyrin IX contains a ferric iron (Fe³⁺) ion with a coordinating chloride ligand.

Hematin is a specific form of heme in which protoporphyrin IX contains a ferric iron (Fe³⁺) ion with a coordinating hydroxide ion.

The heme precursor can be obtained from a non-plant origin (such as eggshell), which is a sustainable source. In particular, eggshells from non-genetically modified animals can be used, thus eliminating the concerns of non-genetic modified organism origins. Eggshells are currently regarded as waste in liquid eggs industries, and being able to use these “waste” solves environmental issues and is green. It is also a cheap source of heme precursor.

Structurally identical protoporphyrin IX may also be extracted from animal blood, such as porcine or bovine blood.

The heme precursor can also be obtained from a plant, alga or bacterium, which expands the available sources of PPY9. For example, the plant source may be spinach.

As PPY9 conversion may be fine tuned via chemical synthesis, the taste provided by the heme and consequently by the heme food product can be tuned. For example, the heme molecule can be modified through the attachment of additional ligand molecules to the central metal ion (via the formation of dative bonds) or by covalently linking to the heme's organic scaffold to form heme a, heme c, heme o and/or hemozoin. For example, the carboxylic functionalities on the heme molecule can undergo an amide coupling reaction to append a histidine or imidazole moiety, which can subsequently then form a dative bond at the axial location of Fe²⁺ central ion. Alternatively, independent and discrete ligands, such as CO molecules, can readily bind to the Fe²⁺ central ion through the formation of strong and robust dative bonds. These modifications modulate the electrochemical properties and catalytic activity of heme, resulting in the production of different flavour and aromatic compounds during cooking as compared to unmodified heme. In contrast, Impossible™ Foods' heme product is obtained via genetically modified yeasts and is limited as the meat taste is solely attributed by varying the concentration of the heme in the plant based product.

The present invention relates to synthesising heme directly through metalation reactions (insertion of Fe^{2+/3+} ions into the porphyrin ring of PPY9 that comes from eggshells). In contrast, Impossible™ Foods' heme is made by genetically modified yeast with soy-leghemoglobin gene. Impossible™ Foods add the soy-leghemoglobin to their plant based protein and not heme directly. Through cooking, heme is released due to thermal degradation of the soy-leghemoglobin protein.

Accordingly, the present invention provides a method of synthesising heme, comprising:
a) extracting crude protoporphyrin IX from a plant, algal, bacterial and/or animal source using an extraction solvent;
b) purifying the crude protoporphyrin IX in order to form purified protoporphyrin IX;
c) metalating the purified protoporphyrin IX with an iron salt and in the presence of a base in order to form heme;
   wherein the extraction solvent is a mixture of an acid and an organic solvent.

In some embodiments, the method of synthesising heme, comprises:
a) extracting crude protoporphyrin IX from a plant, algal, bacterial and/or animal source using an extraction solvent;
b) purifying the crude protoporphyrin IX in order to form purified protoporphyrin IX;
c) metalating the purified protoporphyrin IX with an iron salt, in the presence of a base and under inert conditions in order to form heme;
   wherein the extraction solvent is a mixture of an acid and an organic solvent.

In some embodiments, the plant, algal, bacterial and/or animal source is eggshell. In some embodiments, the eggshell is derived from eggs of Gallus gallus domesticus (Chicken), Anas platyrhynchos domesticus (Duck), Coturnix genus (Quails), or a combination thereof.

Animal sources can also include animal bodily fluids (i.e. blood or intramuscular fluid, including plasma and platelets), which contains heme-containing proteins such as, but not limited to, hemoglobin and myoglobin proteins. These bodily fluids can be derived from the slaughter of domesticated animals reared for human consumption including, but not limited to, Gallus gallus domesticus (Chicken), Anas platyrhynchos domesticus (Duck), Bos primigenius taurus (Cow), Suinae sus domesticus (Pig), Capra capra hircus (Goat) and Ovis ovis aries (Sheep).

In some embodiments, the animal source is a blood source. The blood may be derived from porcine or bovine. In some embodiments, the animal source is a non-blood source. In some embodiments, the animal source is not blood, plasma or platelet.

In some embodiments, the plant, algal or bacterial sources is selected from photosynthetic plants, photosynthetic algae, non-photosynthetic algae, cyanobacteria organisms containing chlorophyll, or a combination thereof. Accordingly, fungi are not included within this scope. These plant, algal and bacterial sources generate protoporphyrin IX as a precursor of chlorophyll. For example, plant sources include organisms from Kingdom Plantae. Algae sources include organisms from the Chlorophyta phylum. Cyanobacteria include organisms from the Cyanobacteria phylum, such as, but not limited to, Arthrospira platensis, Arthrospira fusiformis and Arthrospira maxima. PPY9 and Heme may be obtained from non-photosynthetic algae as they contain the cellular machinery for PPY9 and Heme biosynthesis, and therefore would produce and possess these molecules.

In some embodiments, the acid in the extraction solvent is an inorganic acid, organic acid, or a combination thereof. In some embodiments, the acid is selected from hydrochloric acid, hydrobromic acid, hydroiodic acid, sulphuric acid, nitric acid, glacial acetic acid, formic acid, or a combination thereof.

In some embodiments, the organic solvent in the extraction solvent is a polar solvent. In some embodiments, the organic solvent is selected from acetone, methanol, ethanol, isopropanol, ethyl acetate, propyl acetate, butyl acetate, alkyl ester, or a combination thereof. In some embodiments, the alkyl ester is derived from a C₁₋₅ alcohol and C₁₋₅ carboxylic acid. In some embodiments, the C₁₋₅ carboxylic acid is selected from formic acid, acetic acid, acetoacetic acid, 2-hydroxypropionic acid, 2-oxopropionic acid, malonic acid, maleic acid, malic acid, fumaric acid, or a combination thereof. In some embodiments, the C₁₋₅ alcohol is selected from methanol, ethanol, propanol, butanol, pentanol, or a combination thereof.

In some embodiments, the extraction step further comprises stirring the plant and/or animal source in the extraction solvent at about 15° C. to about 60° C. In other embodiments, the temperature is about 15° C. to about 55° C., about 15° C. to about 50° C., about 15° C. to about 45° C., about 15° C. to about 40° C., about 15° C. to about 35° C., about 15° C. to about 30° C., or about 15° C. to about 25° C. In other embodiments, the temperature is ambient temperature.

In some embodiments, the extraction step further comprises stirring the plant and/or animal source in the extraction solvent at a reduced pressure. In some embodiments, the extraction step further comprises stirring the plant and/or animal source in the extraction solvent at about 600 mmHg to about 900 mmHg. In other embodiments, the pressure is atmospheric pressure.

In some embodiments, the extraction step is performed for about 30 min to about 4 h. In other embodiments, the duration is about 30 min to about 3 h, about 30 min to about 2 h, or about 30 min to about 1 h.

In some embodiments, the extraction step further comprises filtering the plant and/or animal source in the extraction solvent in order to obtain the crude protoporphyrin IX dissolved in a filtrate.

In some embodiments, the extraction step further comprises basifying the filtrate with a base in order to precipitate the crude protoporphyrin IX as a solid.

In some embodiments, the base is an inorganic base. In some embodiments, the base is selected from lithium hydroxide, sodium hydroxide, potassium hydroxide, ammonium hydroxide, or a combination thereof.

As the crude protoporphyrin IX is derived from an edible plant, algal, bacterial and/or animal source, it can be used as is, or can be further purified to improve its colouration and taste. In some embodiments, the purification step comprises the dissolving the crude protoporphyrin IX in a polar solvent, filtering the crude protoporphyrin IX in the polar solvent in order to obtain a filtrate and removing the polar solvent from the filtrate.

In some embodiments, the polar solvent is a polar aprotic solvent. In some embodiments, the polar solvent is selected from dimethyl sulfoxide, N,N-dimethylformamide, or a combination thereof.

Iron is then complexed with protoporphyrin IX. The iron can be an iron (II), iron (III), or a combination thereof. In some embodiments, the iron(II) salt is selected from iron(II) chloride, iron(II) bromide, iron(II) iodide, iron(II) sulphate, iron(II) nitrate, iron(II) fumarate, iron(II) gluconate, their hydrates thereof, or a combination thereof. In some embodiments, the iron (III) salt is selected from iron(III) chloride, iron(III) bromide, iron(III) iodide, iron(III) sulphate, iron(III) nitrate, iron(III) fumarate, iron(III) gluconate, their hydrates thereof, or a combination thereof.

When Fe²⁺ is complexed with protoporphyrin IX, the solution thereof appears red. When Fe³⁺ is complexed with protoporphyrin IX, the solution thereof appears dark brown. When dried, both complexes appear as black solids.

In some embodiments, the base is selected from metal hydroxide, metal bicarbonate, metal carbonate, metal oxide, or a combination thereof. In some embodiments, the metal is selected from sodium, potassium, magnesium, calcium, or a combination thereof.

In some embodiments, the metalation step is performed in the presence of a solvent. In some embodiments, the solvent is selected from formic acid, acetic acid, acetone, ethanol, dimethyl sulfoxide, N,N-dimethylformamide, or a combination thereof.

In some embodiments, metalation step is performed under inert conditions. In some embodiments, the inert condition is inert gas selected from helium, argon, nitrogen, carbon dioxide, or a combination thereof.

Oxygen free conditions may be used to prevent interaction between Heme and dioxygen. Dioxygen can oxidise the heme's Fe²⁺ center and form a bridging bidentate oxo μ²—O₂ ligand between two heme molecules. This irreversibly deactivate the heme molecule. In particular, carbon dioxide is found to be advantageous as it is chemically inert and would bind to the axial locations of the Fe²⁺ center, preventing its reaction with other ligands.

In some embodiments, the metalation step is performed at a temperature at about 50° C. to about 190° C. For example, the temperature can be about the boiling point temperature of the solvent. In other embodiments, the temperature is about 50° C. to about 180° C., about 50° C. to about 170° C., about 50° C. to about 160° C., about 50° C. to about 150° C., about 50° C. to about 140° C., about 50° C. to about 130° C., about 50° C. to about 120° C., about 50° C. to about 110° C., about 50° C. to about 100° C., about 50° C. to about 90° C., about 50° C. to about 80° C., about 50° C. to about 70° C., or about 50° C. to about 60° C.

In some embodiments, the metalation step is performed for about 4 h to about 24 h. This can be dependent on the rate of completion of the metalation step. For example, aliquots can be taken at time points to assess the complexation percentage, as analysed using mass spectroscopy. In other embodiments, the timing is about 4 h to about 22 h, about 4 h to about 20 h, about 4 h to about 18 h, about 4 h to about 16 h, about 4 h to about 14 h, about 4 h to about 12 h, about 4 h to about 10 h, about 4 h to about 8 h, or about 4 h to about 6 h.

In some embodiments, the metalation step further comprises acidifying the heme in order to precipitate heme as a solid. In some embodiments, the acid is selected from hydrochloric acid, hydrobromic acid, hydroiodic acid, sulphuric acid, nitric acid, or a combination thereof.

In some embodiments, when Fe³⁺ is used, heme can be complexed with an anion. For example, when the anion is Cl⁻, hemin is produced after the metalation step. Accordingly, the process can optionally comprises a step of converting heme salt into heme by removing the anion associated with the iron complex. For example, heme salt can be converted into heme through the in-situ reduction of hemin using a food grade reductant, such as L-ascorbic acid or any other single electron donor antioxidant. The reduction causes the oxidation state of the central Fe ion to change from +3 to +2. The reduction simultaneously liberates the anion from the heme, and the anion is subsequently dissolved in water while heme remains insoluble. The heme is then thoroughly washed with water to remove the unwanted anions.

The method provides a heme with a purity of at least 80%. In some embodiments, the method is characterised by a heme purity of at least 80%, 82%, 84%, 86%, 88%, 90%, 92%, 94%, 96%, 98% or 99%.

In some embodiments, the method is characterised by a presence of hemin. Hemin may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of hematin. Hematin may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of an impurity. The impurity may be a heme analog, precursor, or derivative. For example, the impurity may be Protoporphyrinogen IX, Coporphyrinogen III, Uroporphyrinogen III, Coporphyrin, Uroporphyrin, pentacarboxylic porphyrin, or a combination thereof. These impurities may be present in small amounts as a result of the heme extraction process.

In some embodiments, the method is characterised by a presence of Protoporphyrinogen IX. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of Coporphyrinogen III. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of Uroporphyrinogen III. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of Coporphyrin. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of Uroporphyrin. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of pentacarboxylic porphyrin. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the method is characterised by a presence of one or more impurities. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

The present method provides for an extraction at about 0.1% w/w to about 15% w/w relative to the mass of the plant, algal, bacterial and/or animal source. The clean, green, and non-GMO source of heme is believed to be palatable to consumers, and thus can be commercially viable.

In some embodiments, the method is characterised by an extraction at about 50% to about 100% relative to the total protoporphyrin IX present in the plant, algal, bacterial and/or animal source. In some embodiments, the method is characterised by an extraction at about 50% to about 100% of the total protoporphyrin IX present in eggshell. In other embodiments, the extraction is about 50% to about 95%, about 50% to about 90%, about 50% to about 85%, about 50% to about 80%, about 50% to about 75%, about 50% to about 70%, about 50% to about 65%, or about 50% to about 60%.

The present invention also provides a heme composition, comprising:
a) heme at about 0.05% w/w to about 1% w/w relative to the heme composition; and
b) an antioxidant at about 0.25% w/w to about 5% w/w relative to the heme composition.

As mentioned above, the heme is derived from PPY9 from a plant, algal, bacterial and/or animal source.

Accordingly, in some embodiments, the heme composition comprises:
a) heme at about 0.05% w/w to about 1% w/w relative to the heme composition; and
b) an antioxidant at about 0.25% w/w to about 5% w/w relative to the heme composition;
   wherein the heme is derived from protoporphyrin IX from a plant, algal, bacterial and/or animal source.

In some embodiments, the heme composition is a biphasic mixture. The heme composition being a biphasic mixture is a feature of its constitution of the solvent system used, which comprises of two solvents (namely aqueous and oil layers) which are immiscible with each other. The heme composition can also take the form of an oil-in-water or water-in-oil emulsified liquid system, semi-solid gel, suspension (consisting of insoluble solids in liquid, which can either be water or oil), monophasic liquid system or solid systems, depending on formulation.

The heme composition can be added to alternative meat products to provide an animal meat-like taste to these products. The components of the composition are provided at effective amounts such that the composition can be added as a whole to these products at varying amounts to alter the meat-like taste profile.

In some embodiments, the heme comprises protoporphyrin IX and an iron salt, wherein the heme is generated when heat is applied to the heme composition. This allows the shelf life of the heme composition to be extended.

In some embodiments, the heme concentration is about 0.05% w/w to about 0.9% w/w, about 0.05% w/w to about 0.8% w/w, about 0.05% w/w to about 0.7% w/w, about 0.05% w/w to about 0.6% w/w, about 0.05% w/w to about 0.5% w/w, about 0.05% w/w to about 0.4% w/w, about 0.05% w/w to about 0.3% w/w, about 0.05% w/w to about 0.2% w/w, or about 0.05% w/w to about 0.1% w/w.

Antioxidants are compounds that inhibit oxidation, a chemical reaction that can produce free radicals and chain reactions that may damage the cells of organisms. Antioxidants such as thiols, ascorbic acid (vitamin C), vitamin A and E may act to inhibit these reactions. In some embodiments, the antioxidant is selected from DL-α-tocopherol, butylated hydroxyanisole (BHA), butylated hydroxytoluene, propyl gallate, trihydroxybutyrophenon (THBP), nordihydroguaiaretic acid, t-butylhydroquinone (TBHQ), dilauryl thiodiopropionate, ascorbic acid, sodium ascorbate, potassium ascorbate, erythorbic acid, ascorbyl palmitate, ascorbyl acetal, or a combination thereof.

It was found that addition of antioxidants can convert heme salt (or hemin) into heme and further stabilises the heme molecule.

In some embodiments, the antioxidant concentration is about 0.25% w/w to about 4.5% w/w, about 0.25% w/w to about 4% w/w, about 0.25% w/w to about 3.5% w/w, about 0.25% w/w to about 3% w/w, about 0.25% w/w to about 2.5% w/w, about 0.25% w/w to about 2% w/w, about 0.25% w/w to about 1.5% w/w, about 0.25% w/w to about 1% w/w, about 0.25% w/w to about 0.9% w/w, about 0.25% w/w to about 0.8% w/w, about 0.25% w/w to about 0.7% w/w, about 0.25% w/w to about 0.6% w/w, about 0.25% w/w to about 0.5% w/w, about 0.25% w/w to about 0.4% w/w, or about 0.25% w/w to about 0.3% w/w.

The heme composition can comprise other solid food additives. For example, the heme composition can comprise amino acids, flavour enhancers, sugars, salts, or a combination thereof.

In some embodiments, the heme composition further comprises an amino acid of about 2% w/w to about 40% w/w relative to the heme composition. Amino acids can be added to initiate the Maillard and Strecker degradation reactions, which are cooking reactions responsible for producing meaty aromatic compounds. In other embodiments, the amino acid concentration is about 2% w/w to about 35% w/w, about 2% w/w to about 30% w/w, about 2% w/w to about 25% w/w, about 2% w/w to about 20% w/w, about 2% w/w to about 15% w/w, about 2% w/w to about 10% w/w, about 2% w/w to about 9% w/w, about 2% w/w to about 8% w/w, about 2% w/w to about 7% w/w, about 2% w/w to about 6% w/w, about 2% w/w to about 5% w/w, about 2% w/w to about 4% w/w, or about 2% w/w to about 3% w/w.

The common natural forms of amino acids have the structure —NH₃⁺ (—NH₂⁺— in the case of proline) and —CO₂⁻ functional groups attached to the same C atom, and are thus α-amino acids. With the exception of achiral glycine, natural amino acids have the L configuration. The L and D convention for amino acid configuration refers to the optical activity of the isomer of glyceraldehyde from which that amino acid can be synthesized (D-glyceraldehyde is dextrorotatory; L-glyceraldehyde is levorotatory). Alternatively, (S) and (R) designators can be used to specify the absolute configuration. Almost all of the amino acids in proteins are (S) at the a carbon, with cysteine being (R) and glycine non-chiral.

In some embodiments, the amino acid is selected from D-amino acid, L-amino acid, DL-amino acid or their respective dipeptide, tripeptide, oligopeptide and polypeptide thereof. In some embodiments, the amino acid is glutamate.

In some embodiments, the heme composition further comprises a flavour enhancer at about 2% w/w to about 45% w/w relative to the heme composition.

In other embodiments, the concentration is about 2% w/w to about 40% w/w, about 2% w/w to about 35% w/w, about 2% w/w to about 30% w/w, about 2% w/w to about 25% w/w, about 2% w/w to about 20% w/w, about 2% w/w to about 15% w/w, about 2% w/w to about 12% w/w, about 2% w/w to about 11% w/w, about 2% w/w to about 10% w/w, about 2% w/w to about 9% w/w, about 2% w/w to about 8% w/w, about 2% w/w to about 7% w/w, about 2% w/w to about 6% w/w, about 2% w/w to about 5% w/w, about 2% w/w to about 4% w/w, or about 2% w/w to about 3% w/w.

Flavour enhancers are compounds that are added to a food in order to supplement or enhance its own natural flavour. In some embodiments, the flavour enhancer is selected from animal-based and plant-based lipids such as short (5 carbon atoms or less), medium (6 to 12 carbon atoms), long (13 to 21 carbon atoms) and very long-chained (22 carbon atoms or more) saturated and/or unsaturated fatty acids either in their free fatty acid forms and/or contained within a triglyceride or phospholipid molecule, nucleoside, nucleotide, vitamin, protein hydrolysate from animal, plant, fungal, bacterial and/or in vitro origin, lecithin, or a combination thereof.

In some embodiments, the flavour enhancer is selected from glutamic acid (E620), disodium inosinate (E631), disodium guanylate (E627), thiamine hydrochloride (FEMA1030), or a combination thereof.

In some embodiments, the heme composition further comprises a sugar at about 1% w/w to about 20% w/w relative to the heme composition. Sugar is added as a reactant to initiate Maillard and Strecker degradation reactions, which is the cooking reaction responsible for producing meaty aromatic compounds. In other embodiments, the sugar concentration is about 1% w/w to about 18% w/w, about 1% w/w to about 16% w/w, about 1% w/w to about 14% w/w, about 1% w/w to about 12% w/w, about 1% w/w to about 10% w/w, about 1% w/w to about 8% w/w, about 1% w/w to about 7% w/w, about 1% w/w to about 6% w/w, about 1% w/w to about 4% w/w, about 1% w/w to about 3% w/w, about 1% w/w to about 2% w/w, or about 1% w/w to about 1.5% w/w.

In some embodiments, the sugar is selected from monosaccharide, disaccharide, oligosaccharide, polysaccharide or their derivatives thereof. In other embodiments, the sugar is selected from glucose, fructose, galactose, xylose, sucrose, lactose, maltose, isomaltulose, trehalose, sorbitol, mannitol, amylose, amylopectin, pectin, or a combination thereof.

In some embodiments, the heme composition further comprises sodium chloride at about 0.5% w/w to about 15% w/w relative to the heme composition. In other embodiments, the NaCl concentration is about 0.5% w/w to about 14% w/w, about 0.5% w/w to about 13% w/w, about 0.5% w/w to about 12% w/w, about 0.5% w/w to about 11% w/w, about 0.5% w/w to about 10% w/w, about 0.5% w/w to about 8% w/w, about 0.5% w/w to about 6% w/w, about 0.5% w/w to about 5% w/w, about 0.5% w/w to about 4.5% w/w, about 0.5% w/w to about 4% w/w, about 0.5% w/w to about 3.5% w/w, about 0.5% w/w to about 3% w/w, about 0.5% w/w to about 2.5% w/w, about 0.5% w/w to about 2% w/w, about 0.5% w/w to about 1.5% w/w, or about 0.5% w/w to about 1% w/w.

In some embodiments, the heme composition further comprises a solvent, the solvent comprising:
a) water at about 40% w/w to about 60% w/w relative to solvent;
b) oil at about 17.5% w/w to about 35% w/w relative to solvent; and
c) a humectant at about 5% w/w to about 2⁵% w/w relative to solvent.

In some embodiments, the water is about 45% w/w to about 60% w/w, about 50% w/w to about 60% w/w, or about 55% w/w to about 60% w/w.

In some embodiments, the oil is about 18% w/w to about 35% w/w, about 20% w/w to about 35% w/w, about 22% w/w to about 35% w/w, about 24% w/w to about 35% w/w, about 26% w/w to about 35% w/w, about 28% w/w to about 35% w/w, or about 30% w/w to about 35% w/w.

In some embodiments, the oil is selected from coconut oil, algal oil, corn oil, soybean oil, palm fruit oil, palm kernel oil, safflower oil, flaxseed oil, rice bran oil, cottonseed oil, sunflower oil, canola oil, olive oil, or a combination thereof.

A humectant is a hygroscopic substance used to keep things moist. In some embodiments, the humectant is selected from lactic acid, acetic acid, glycerol, or a combination thereof.

In some embodiments, the humectant concentration is about 5% w/w to about 24% w/w, about 5% w/w to about 23% w/w, about 5% w/w to about 22% w/w, about 5% w/w to about 21% w/w, about 5% w/w to about 20% w/w, about 5% w/w to about 19% w/w, about 5% w/w to about 18% w/w, about 5% w/w to about 17% w/w, about 5% w/w to about 16% w/w, about 5% w/w to about 15% w/w, about 5% w/w to about 14% w/w, about 5% w/w to about 13% w/w, about 5% w/w to about 12% w/w, about 5% w/w to about 11% w/w, about 5% w/w to about 10% w/w, about 5% w/w to about 9% w/w, about 5% w/w to about 8% w/w, or about 5% w/w to about 7% w/w.

In some embodiments, the solvent further comprises pH modulator at about 0.75% w/w to about 3% w/w relative to solvent. pH modulators are used to adjust the heme composition's pH to the range of pH 5 to 9, which are optimal pH ranges that favour the formation of palatable and pleasant volatile chemical products during cooking reactions. In other embodiments, the concentration is about 0.75% w/w to about 2.5% w/w, about 0.75% w/w to about 2% w/w, or about 0.75% w/w to about 1.5% w/w.

In some embodiments, the pH modulator is selected from acidic pH modulators including food grade acids such as hydrochloric acid, hydrobromic acid, hydroiodic acid, glacial acetic acid or formic acid, or a combination thereof. Basic pH modulators include food grade bases such as hydroxides, carbonates and bicarbonates of lithium, sodium, potassium, and ammonium, or a combination thereof.

The present invention also provides a heme food product, comprising:
a) heme composition at about 9% w/w to about 11% w/w relative to the heme food product; and
b) an alternative protein at about 15% w/w to about 40% w/w relative to the heme food product;
   wherein heme is about 0.002% w/w to about 0.06% w/w relative to the heme food product.

In some embodiments, the concentration of the heme composition is about 10% w/w to about 11% w/w.

In some embodiments, the concentration of the alternative protein is about 20% w/w to about 40% w/w, about 25% w/w to about 40% w/w, about 30% w/w to about 40% w/w, or about 35% w/w to about 40% w/w.

In some embodiments, the alternative protein is derived from a source selected from plant, insect, fungus, bacteria, in vitro cultured animal cells, or a combination thereof. In vitro cultured cells include those derived from Mammalia (Mammals), Actinopterygii (Fish), Insecta (Insect), Cephalopoda (Cephalopods) classes, Crustacea (Crustacean) subphylum, and Mollusca (mollusc) phylum. In some embodiments, the alternative protein is derived from a plant source selected from soy, pea, wheat, lentil, lupin, vetch, chickpea, cowpea, pigeon pea, adzuki bean, bambara bean, black bean, fava bean, kidney bean, lima bean, long bean, mung bean, navy bean, tepary bean, velvet bean, yam bean, oat, rice, quinoa, buckwheat, amaranth, camelina seed, hemp seed, pumpkin seed, rapeseed, sunflower seed, peanut, cashew nut, potato, jackfruit, duckweed, sweet potato, tapioca or a combination thereof. In some embodiments, the alternative protein is derived from a fungus source selected from Aspergillus spp., Agrocybe spp. (Poplar mushrooms), Fusarium spp. (Microfungus), Komagataella spp. Rhizopus spp., Saccharomyces spp., Zygosaccharomyces spp., Agaricus bisporus (button mushroom), Flammulina filiformis (enokitake), Grifola frondosa (maitake), Lentinula edodes (shiitake), Lyophyllum shimeji (hon-shimeji), Morchella spp. (morels), Pleurotus spp. (oyster mushrooms), Volvariella volvacea (straw mushroom), or a combination thereof. In some embodiments, the alternative protein is derived from an insect source selected from the Insecta Class.

The resultant heme concentration in the heme food product is about 0.002% w/w to about 0.05% w/w relative to the heme food product. It was found that when within this range, a meaty taste profile can be achieved and which is not deemed to be too “bloody” or astringent. In other embodiments, the heme concentration is about 0.005% w/w to about 0.05% w/w, about 0.01% w/w to about 0.015% w/w, about 0.02% w/w to about 0.05% w/w, about 0.025% w/w to about 0.05% w/w, about 0.03% w/w to about 0.05% w/w, about 0.035% w/w to about 0.05% w/w, about 0.04% w/w to about 0.05% w/w, or about 0.045% w/w to about 0.05% w/w.

In some embodiments, the heme food product further comprises a vegetable oil at about 5% w/w to about 15% w/w relative to the heme food product. In some embodiments, the concentration of vegetable oil is about 6% w/w to about 15% w/w, about 7% w/w to about 15% w/w, about 8% w/w to about 15% w/w, about 9% w/w to about 15% w/w, about 10% w/w to about 15% w/w, about 11% w/w to about 15% w/w, about 12% w/w to about 15% w/w, or about 13% w/w to about 15% w/w.

In some embodiments, the heme food product further comprises a food flavouring at about 2.5% w/w to about 25% w/w relative to the heme food product. In other embodiments, the concentration is about 2.5% w/w to about 20% w/w, about 2.5% w/w to about 15% w/w, about 2.5% w/w to about 10% w/w, or about 2.5% w/w to about 5% w/w.

In some embodiments, the heme food product further comprises a stabiliser at about 1% w/w to about 4% w/w relative to the heme food product. In other embodiments, the concentration is about 2% w/w to about 4% w/w, or about 3% w/w to about 4% w/w. The stabiliser may be a hydrocolloid such as alginate, agar, carrageen, cellulose and cellulose derivatives, gelatin, guar gum, gum Arabic, locust bean gum, pectin, starch, and xanthan gum.

In some embodiments, the heme food product further comprises a food colouring at about 0.035% w/w to about 0.5% w/w relative to the heme food product. In other embodiments, the concentration is about 0.05% w/w to about 0.5% w/w, about 0.1% w/w to about 0.5% w/w, about 0.15% w/w to about 0.5% w/w, about 0.2% w/w to about 0.5% w/w, about 0.25% w/w to about 0.5% w/w, about 0.3% w/w to about 0.5% w/w, about 0.35% w/w to about 0.5% w/w, or about 0.4% w/w to about 0.5% w/w.

### EXAMPLES

### Example 1: Sustainable Extraction of Protoporphyrin IX from Eggshells and its Processing to Food-Grade Heme

Extraction of Protoporphyrin IX (PPY9) from eggshells in the literature are mostly for analytical and characterization purposes and never for food applications. The solvents used in those literature tend to be toxic. Here, food safe reagents is used to extract sufficiently high yield of PPY9 from eggshells (FIG. 2).

The extraction method for PPY9 from eggshells uses an extraction solvent mixture comprising of an inorganic or organic acid (A) and an organic solvent (B). The liquid portion is isolated and then basified using a solution of an inorganic base (C) to deposit crude PPY9. The crude PPY9 is then dissolved in another polar organic solvent (D), where only PPY9 has a high solubility. PPY9 is then obtained by removing the solvent in vacuo.

Eggshells include those derived from the eggs of Gallus Gallus Domesticus (Chicken), Anas Platyrhynchos Domesticus (Duck) and those of the Coturnix genus (Quails). Acid A include food grade acids like hydrochloric acid, hydrobromic acid, hydroiodic acid, sulphuric acid, nitric acid, glacial acetic acid and formic acid. Organic solvent B include food grade solvents acetone, methanol, ethanol, isopropanol, ethyl acetate, propyl acetate, butyl acetate or any other lower alkyl esters formed from alcohol and carboxylic acid components which are 1 to 5 carbon atoms long, such as esters formed between carboxylic acids such as formic acid, acetic acid, acetoacetic acid, 2-hydroxypropionic acid, 2-oxopropionic acid, malonic acid, maleic acid, malic acid and fumaric acid and alcohols such as methanol, ethanol, propanol, butanol and pentanol. Inorganic base C includes hydroxides of lithium, sodium, potassium and ammonium. Polar organic solvent D include dimethyl sulfoxide and N,N-dimethylformamide.

### A Typical Extraction Example (FIG. 2)

Acid A and Organic solvent B were added to crushed eggshells to liberate PPY9 from the eggs' shell layers. The mixture is stirred at room temperature and pressure until the eggshells became bleached. The solution was filtered and the filtrate was isolated. The filtrate was basified. The resultant suspension was centrifuged, and the residue was isolated. Solvent D was added and the resultant suspension was filtered and the filtrate was isolated. The filtrate was then evaporated in vacuo, forming PPY9 as a black solid.

Characterisation: MS(ESI) for C₃₄H₃₅N₄O₄: m/z=563 [M+H]⁺. HPLC purity: peak area=83.6% at 398 nm. IR analysis: 3310 (N—H), 2917 (O—H), 1696 (C═O), 1402 (C═CH₂) cm⁻¹. UV-vis: (1:1 H₂O+0.1% TFA:CH₃CN+0.1% TFA) λₘₐₓ=404 nm

Sustainable Novel Food Grade Extraction of Protoporphyrin IX and Similar Molecules from Plant Material

Briefly, plant materials are either crushed, or frozen and then crushed. PPY9 and similar molecules dissolved in a blend of organic solvents (e.g. acetone and vegetable oils) (FDA approves acetone less than 30 ppm). Subsequently, PPY9 mixture is further processed by addition of disodium EDTA (FDA approves at less than 500 ppm). Similar molecules includes Protoporphyrinogen IX, Coporphyrinogen III, Uroporphyrinogen III, Coporphyrin, Uroporphyrin and pentacarboxylic porphyrin. They may be converted into PPY9 through a series of decarboxylation and oxidation reactions mediated by specific enzymes or chemoselective chemical transformations and therefore may be used to synthesize Heme. For example, coproporphyrinogen III may be derived from uroporphyrinogen III by the action of the enzyme uroporphyrinogen III decarboxylase. Coproporphyrinogen III may be oxidised by enzyme coproporphyrinogen III oxidase and further decarboxylated to protoporphyrinogen IX. Protoporphyrinogen IX may be converted into protoporphyrin IX via protoporphyrinogen oxidase.

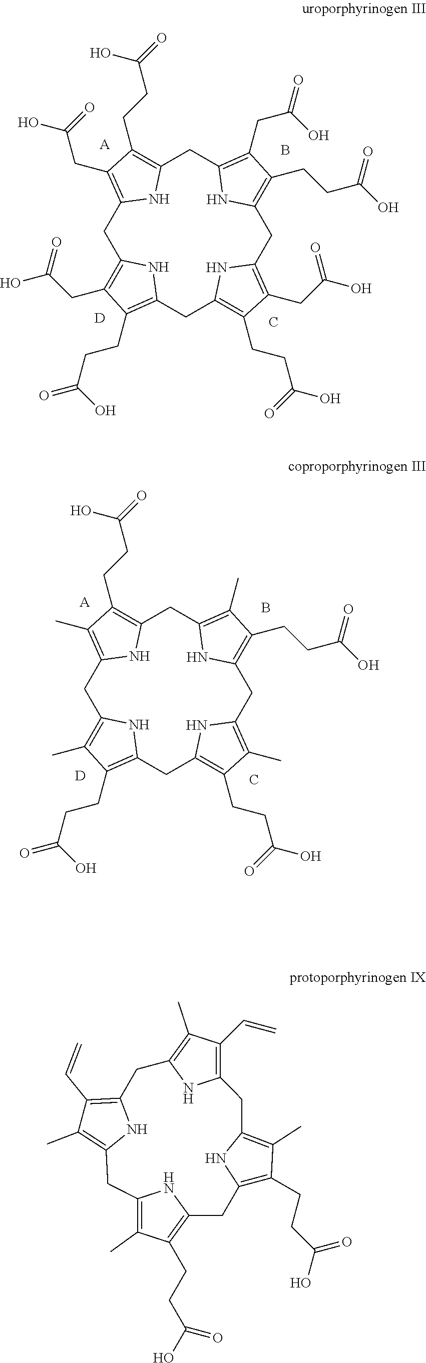

### Food-Safe Synthesis of Heme

The preparation of Heme from the chemical reaction between PPY9, a food-safe iron(II) salt (E) and a food-safe inorganic base (F), wherein the iron(II) cation is inserted into PPY9's porphyrin ring structure. PPY9 and E are dissolved in food-safe organic solvent (G), in which PPY9 has a high solubility in. The reaction mixture is heated under inert gas atmosphere (H) for a period of 4-12 hours. Thereafter, the mixture was acidified using acid (I) to deposit heme salt (or Hemin if the anion is chloride) as a solid. The solid heme salt product is isolated to yield heme of high purity.

Iron(II) salt E include food grade iron(II) chloride, iron(II) bromide, iron(II) iodide, iron(II) sulphate, iron(II) nitrate, iron(II) fumarate, iron(II) gluconate and their respective hydrates. Food-safe inorganic base F refers to hydroxides, bicarbonates, carbonates, oxides of sodium, potassium, magnesium and calcium. Food-safe organic solvent G include formic acid, acetic acid, acetone, ethanol, dimethyl sulfoxide and N,N-dimethylformamide. Inert gas H include gases such as helium, argon, nitrogen and carbon dioxide. Acid I include inorganic acids like hydrochloric acid, hydrobromic acid, hydroiodic acid, sulphuric acid and nitric acid.

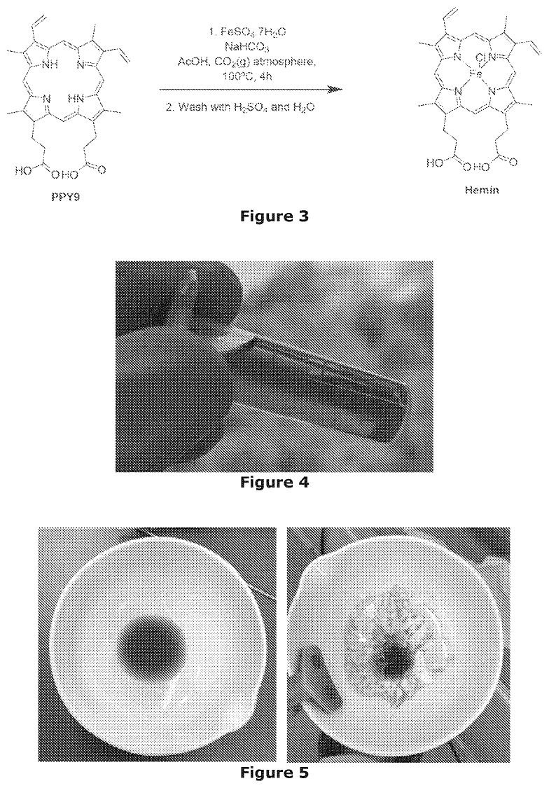

### A Typical Synthesis Example (FIG. 3)

Protoporphyrin IX (PPY9) and sodium bicarbonate (NaHCO₃) were dissolved in acetic acid (AcOH). FeSO₄·7H₂O was dissolved in deionised H₂O. The AcOH solution was heated to 100° C. under a CO₂ (g) atmosphere, after which the FeSO₄ solution was added to the reaction solution. The reaction solution was heated for 4-12 h. The solvents were removed by evaporation under reduced pressure. H₂SO₄ was added to precipitate the product as a solid. The (hemin) solid was washed twice with H₂SO₄ and H₂O.

Characterisation: MS (ESI) for C₃₄H₃₂FeN₄O₄Cl: m/z=616 [M-Cl]⁺, 650 [M−H]⁻. HPLC purity: peak area=88.5% at 398 nm. IR analysis: 2922 (O—H), 1700 (C=O), 1379 (C═CH₂), 1218, 939, 913, 841 cm⁻¹. UV-vis: (1:1 H₂O+0.1% TFA:CH₃CN+0.1% TFA) λₘₐₓ=398 nm; Elemental analysis: calcd for C₃₄H₃₂FeN₄O₄Cl·1.5H₂O·0.65C₂H₆OS=C, 58.10%; H, 5.37%; N, 7.68%; S, 2.86%; Found=C, 57.86%; H, 5.13%; N, 7.87%; S, 2.74%.

### Applications of Heme

Heme is used for at least three purposes in alternative protein applications; firstly, it is used as a flavouring. Secondly, as a food colourant to mimic the appearance and other organoleptic properties (aroma and/or taste) of meat in alternative protein applications. Lastly, as a highly bioavailable nutritional source of iron.

Alternative protein applications here are defined as any food product intended for human consumption and are designed to resemble animal-based meat organoleptically and nutritionally but are constituted entirely by proteins for example, derived from plants, insects, fungus, bacteria, in vitro source, or a combination thereof. Alternative protein applications from plants include those made from soy, pea, wheat and other vegetables commonly consumed by humans. Alternative protein applications from fungi include those made from Fusarium Venenatum (Microfungus), Pichia Pastoris (Yeast) and other macrofungi commonly consumed by humans. Alternative protein applications from insects include those made from the Insecta Class. Alternative protein applications from in vitro origins include those derived from tissue engineering or cell culturing of animal cells intended for human consumption or nutrition.

The heme food product can take the form of traditional animal-based meat food products such as dumplings, minced meat, hamburger patties, hams, luncheon meats, sausages, hot dogs, steaks, filets, cold cuts, roasts, breasts, wings, thighs, meat slices, meat cubes, meat fillings in Asian (e.g. buns) and western (e.g. pies) pastries, fingers, strips, bacon and nuggets.

The heme food product can be formulated, but is not entirely restricted to, as a solution (e.g. juice), solid (e.g. boullion cube) or a combination thereof (e.g. individual flavour packs intended to be use in tandem).

For the first application, the heme molecule is used to alter the taste and/or aromatic profile of alternative meat products through the participation of heme and flavour and/or odourant precursors in a chemical reaction. In some embodiments, heme functions as a catalyst when thermally activated (i.e. cooking); it enables a myriad of chemical reactions such as Maillard, Strecker degradation, lipid oxidation reactions to occur with greater frequencies and at faster rates, resulting in the production of more numerous flavour and odorous compounds with “meaty”, savoury and other palatable aromas. In some embodiments, the heme molecule decomposes under high temperatures to release the iron ion, which proceeds on to catalyse further cooking reactions. The heme molecule is combined in the presence of antioxidants to activate and prolong the heme's catalytic activity.

Flavour and odourant precursors include monosaccharides, disaccharides, oligosaccharides, polysaccharides and their derivatives, animal-based and plant-based lipids such as short (5 carbon atoms or less), medium (6 to 12 carbon atoms), long (13 to 21 carbon atoms) and very long-chained (22 carbon atoms or more) saturated and/or unsaturated fatty acids either in their free fatty acid forms and/or contained within a triglyceride or phospholipid molecule, DL-amino acids and their respective dipeptides, tripeptides, oligopeptides and polypeptides, nucleosides, nucleotides, vitamins, protein hydrolysates from animal, plant, fungal, bacterial and in vitro origin, lecithin and other food-safe and edible organic molecules. Antioxidants include DL-α-tocopherol, butylated hydroxyanisole (BHA), butylated hydroxytoluene, propyl gallate, trihydroxybutyrophenon (THBP), nordihydroguaiaretic acid, t-butylhydroquinone (TBHQ), dilauryl thiodiopropionate, ascorbic acid, sodium ascorbate, potassium ascorbate, erythorbic acid, ascorbyl palmitate and ascorbyl acetal. A non-limiting example of the list of flavour and/or odourant precursors and antioxidants with heme (herein called “Mixture M”) are shown in Table 1. Flavour enhancers are chemicals with the food additive numbers beginning with the “E6” prefix.

TABLE 1
Typical Ingredient List of “Mixture M”

| | Composition by weight (%) in |
|---|---|
| Chemical | Mixture M, excluding solvent |
| Amino acids (excluding glutamic | 32.0 |
| acid) | |
| Flavour enhancers | 39.2 |
| Glutamic acid (E620) | |
| Disodium inosinate (E631) | |
| Disodium guanylate (E627) | |
| Thiamine Hydrochloride (FEMA1030) | |
| Sugars | 15.4 |
| Sodium Chloride | 9.3 |
| Antioxidant | 3.1 |
| L-ascorbic acid (E300) | |
| Heme | 0.7 |
| Sodium Nitrite (E250) | 0.3 |

If heme salt (or hemin) is present, the antioxidants can convert hemin into heme and further stabilises the heme molecule.

For the second application, the heme molecule is used as a food colourant to impart palatable visual properties (i.e. red colour, colour transitions upon cooking) onto the alternative meat product. The heme molecule is prepared in a specific chemical composition to stabilize its red colour at room temperature and conditions (FIG. 4). Under thermal activation, the heme molecule and its formulation undergoes a colour transition from red to pink to brown colouration which corresponds to the cooked state of the heme-infused alternative meat product. This formulation is a biphasic liquid medium which dissolves heme and comprises of water, food-safe organic solvents (J) and vegetable oil (K). Food-safe organic solvents J act as humectants and include lactic acid, acetic acid and glycerol. Vegetable oil K include coconut oil, algal oil, corn oil, soybean oil, palm fruit oil, palm kernel oil, safflower oil, flaxseed oil, rice bran oil, cottonseed oil, sunflower oil, canola oil, olive oil and any other edible oils derived from commonly grown crops. A non-limiting example of the ingredient list of the aqueous-hydrophobic medium is given in Table 2.

TABLE 2
Typical Ingredient List for aqueous-hydrophobic medium

| | Composition by weight (%), |
|---|---|
| Ingredients | excluding mixture M |
| Water | 46.0 |
| Vegetable oil | 33.0 |
| Humectants | 19.4 |
| pH Control Agents and acidulants | 1.6 |

For the third application, the heme molecule provides a source of highly bioavailable iron nutrition. Heme is the final digested product of hemoproteins, and is a form of iron (called heme iron) that is absorbed by the body via heme-specific protein channel transporters or vesicles of enterocytes. In some embodiments, heme may be supplied in the form of a food additive solution which is added to an alternative meat product for the purposes of providing additional nutrients, modulating the flavour and/or aroma profile and improving the organoleptic properties of a given alternative meat product. In some embodiments, heme may be directly added as a solid food additive into the alternative meat product.

Accordingly, a procedure for the preparation of a food product which includes an iron complex, heme, is described. A methodology for the production of “meaty” and other palatable aromas, which includes combining heme with flavour and/or odourant precursors in an aqueous-hydrophobic medium and heating the mixture is also described.

### A Typical Heme Formulation Example (FIGS. 4 & 5, Tables 1 & 2)

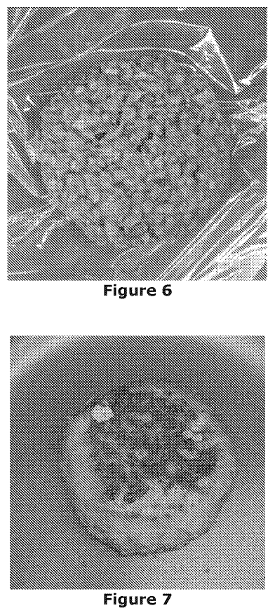

Hemin and Mixture M are dissolved in glacial acetic acid, glycerol and water and plant derived oil to form the red-coloured heme solution (FIG. 4). Heme is generated in-situ when it is combined with Mixture M and dissolved in the aqueous-hydrophobic medium. Upon heating, the colour changes from red to brown (FIG. 5).

### Novel Plant Based Meat

Heme produced above can be added into non-animal protein products such as plant-based meat, mycoprotein-based etc. food products for improving the overall quality of the products such as colour, flavour and nutritional value. In addition, it can also be added to improve consumer satisfaction e.g. satiety. Heme is used in a very small quantity not exceeding 2 mg of elemental iron (or 20 mg of heme) equivalent per 100 g of the final non-animal based product with or without addition of inorganic iron. Such products can be produced through formulation of suitable ingredients including heme in which the quality of the protein is comparable to that of animal protein. Food manufacturers can also ensure the other nutritional qualities of the product is as good as animal protein although this may not be necessary. The heme produced above can also be added before non-animal protein is further processed either through extrusion or other means to produce a desirable texture. Dosing of heme into foods can be improved by producing a carrier containing but not limited to other non-animal based material such as vegetable oil, yeast extract and hydrolysed vegetable protein. The invention here includes the optimisation of the amount of heme to be added to the food products to achieve the desired quality as well as the production of a carrier that is fit for purpose.

### A Plant Based Meat Formulation Example (FIGS. 6 & 7, Table 3)

The plant based meat mixture is made by blending the ingredients indicated in Table 3 together with heme solution. The mixture was shaped into burger patties (FIG. 6). Afterwards, the patties were pan fried for 3 mins at 150° C. to form burger patties (FIG. 7).

TABLE 3
Ingredients used to make burger patties with heme formulation

| Chemical | Composition by weight (%) |
|---|---|
| Water | 55.0 |
| Texturised Vegetable Proteins | 19.0 |
| Vegetable oil | 9.00 |
| Permitted Food Flavourings | 5.00 |
| Stabilisers | 2.00 |
| Permitted Food Colouring | 0.10 |
| Heme composition (solvent + | 9.90 |
| food additives) | |

### Example 2: Addition of Heme Iron to a Specific Mixture of Amino Acids, Sugars and Fatty Acids Increases the Beefy Aroma Compounds in a Concentration-Dependent Manner

The flavour mixtures were produced by using the following ingredients: sodium nitrite (<0.1% w/v), ascorbic acid (<0.1% w/v), L-amino acids, nucleotides, hexoses and pentoses (5 to 10% w/v), beet root extract (1% w/v), glycerol (1 to 5% v/v), salt solution (around 50% v/v), fatty acids (5 to 20% v/v), coconut oil (10 to 15% v/v) and water to make up the balance. Equivalent concentrations of Heme Iron and Inorganic Iron (Iron(II) sulfate heptahydrate) at zero, low, medium and high levels were tested. Control samples were prepared by including all ingredients except iron. Samples were prepared and measured in triplicate.

Each sample was heated separately at 300° C. for 7 min and transferred into 10 mL headspace glass vials. Solid-phase microextraction (SPME) with gas chromatography mass spectrometry (GCMS) was used to analyse the volatile compositions of the flavour mixtures. SPME is a solvent-free chromatographic technique that captures volatile compounds in the head space volume through adsorption onto a coated fibre. The fibre (with the adsorbed volatiles) is then introduced into the GCMS, wherein the volatiles are separated chromatographically and their molecular structures are identified through mass spectrometric methods, in order to elucidate the volatile composition of the flavour mixtures. All peak areas were standardised to an internal standard.

Table 4 shows the variety of aroma volatiles that were detected by the GCMS in the Heme and Inorganic Iron and control samples at medium concentration levels. Flavour mixtures with Heme iron showed the greatest abundance and quantities of volatile products as compared to the Inorganic Iron and Control samples.

TABLE 4
Volatile composition of Heme Iron, Inorganic Iron
and Control Samples at Medium concentrations

| | Retention | Heme | Inorganic | Control |
|---|---|---|---|---|
| Volatile | time (min) | iron | iron | (no Iron) |
| Pentane | 5.475 | M | L | L |
| Octane | 7.4 | L | L | L |
| 2-Propenal | 8.266 | L | L | L |
| Butanal | 8.886 | L | L | L |
| Butanal, 2-methyl- | 9.744 | L | L | L |
| Butanal, 3-methyl- | 9.849 | L | L | L |
| Pentanal | 11.444 | M | L | L |
| Hexanal | 14.196 | H | M | L |
| Heptanal | 16.877 | L | L | L |
| 2,4-Nonadienal | 17.876 | M | L | L |
| 1-Pentanol | 18.519 | L | L | L |
| Octanal | 19.529 | L | L | L |
| 2-Heptenal, (Z)- | 20.588 | H | ND | L |
| 2-Hexenal, (E)- | 20.699 | M | L | ND |
| 2-Octenal, (E)- | 23.41 | M | L | L |
| Fufural | 23.955 | H | H | L |
| Benzaldehyde | 25.784 | M | ND | ND |
| 2-Nonenal, (E)- | 25.883 | M | L | ND |
| 2-Decenal, (E)- | 28.407 | H | M | L |
| 1,2-Propadiene-1,3- | 28.645 | L | L | L |
| dione | | | | |
| Heptadecane | 29.145 | M | L | L |
| 2-Hexyne, 4-methyl- | 29.863 | M | L | L |
| 5-Hexen-2-one | 30.472 | L | ND | L |
| 2-Undecenal, E- | 30.968 | H | L | ND |
| 2-Octyne | 31.249 | H | L | L |
| 2-Tridecanone | 32.184 | L | L | L |
| 2,4-Decadienal, | 32.485 | H | L | L |
| (E,E)- | | | | |
| Hexanoic acid | 32.609 | M | L | L |
| Heptanoic acid | 35.189 | M | L | L |
| 4-Heptenal | 37.073 | H | H | L |
| Octanoic Acid | 37.745 | H | L | M |
| Cyclohexanone, 4- | 39.166 | M | L | L |
| ethyl- | | | | |
| n-Decanoic acid | 43.005 | M | L | L |

ND: not detected;
L: <0.1;
M: 0.1-0.6;
H: >0.6

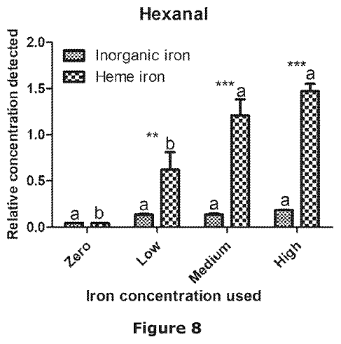

FIG. 8 shows the detected concentrations of the volatile, Hexanal, for Heme Iron and Inorganic Iron samples at different concentration levels. Hexanal is one of the key aroma volatiles responsible for the odour of cooked meats, and is formed mainly through oxidative reactions. The detected concentrations of hexanal were significantly greater for Heme Iron than Inorganic Iron at all equivalent concentrations. The detected concentrations of hexanal also increased in a concentration-dependent manner with increasing concentrations of Heme iron, but not for Inorganic Iron samples. Similar trends were observed for the other volatile, oxidation products for Heme Iron samples.

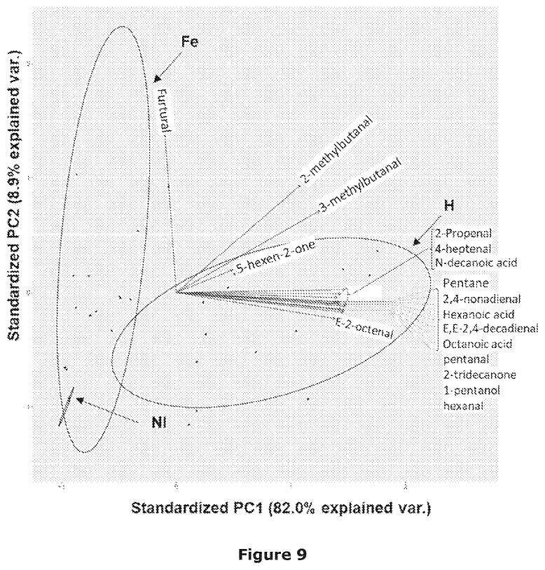

A principal component analysis (PCA) was conducted for the GCMS results produced by the flavour mixtures and the results are shown in FIG. 9. PCA is a statistical method that allows for multivariate data to be translated into a 2-dimensional coordinate plot, to increase interpretability by determining the trends, clusters and outliers. Volatiles were grouped into 2 different components, firstly into oxidation products for the 1st Principal Component (PC1) axis and secondly into Maillard Reaction Products for the 2nd Principal Component (PC2) axis. In this context, PCA was used to visualise the differences in the volatile profiles of the different flavour mixtures.

The Heme Iron samples (labelled H) varied more significantly along the PC1 axis, showing that Heme Iron is associated with the oxidation products. The Inorganic Iron samples (labelled Fe) varied along the PC2 axis, showing that Inorganic Iron is less associated with the oxidation products, but more with Maillard reaction products. Samples with no iron catalyst (labelled NI) did not show great variation in either axes, indicating that the control did not have the same diversity and abundance of volatiles as Heme iron and inorganic iron samples.

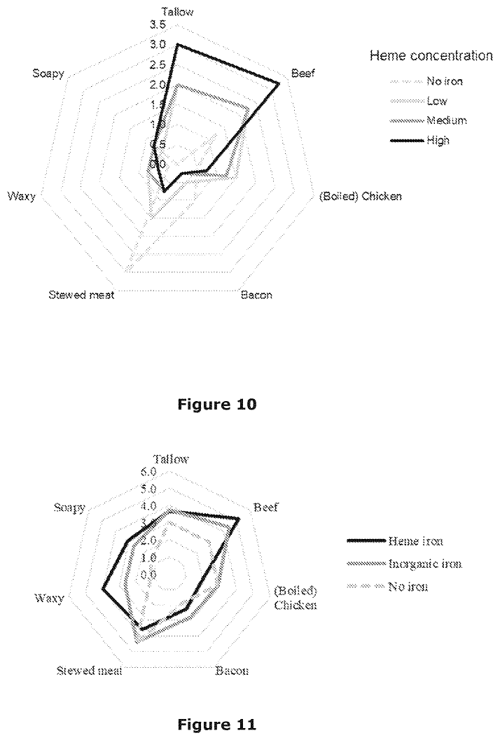

Taken together, Heme Iron samples generally show higher concentrations of volatile compounds that are also found in animal meats. Correspondingly, panelists who olfactory sampled these flavour mixtures described the Heme Iron samples as being significantly more beefy as the Heme Iron concentration increases (see FIG. 10).

### Example 3: Addition of Heme Iron to a Specific Mixture of Amino Acids, Sugars and Fatty Acids Increases the Beefy Aroma of the Mixture

The flavour mixtures were produced using the same ingredients as shown in Example 2. Equimolar amounts of Heme Iron and Inorganic Iron at ‘high’ concentrations were added to compare the effects of Heme Iron against Inorganic Iron. Control samples were prepared by including all ingredients except for any iron catalysts.

The mixture was heated at 300° C. for 7 minutes, and transferred to smelling tubes. The aroma of the mixture was evaluated by a semi-trained sensory panel. The panellists were trained on the seven references shown in Table 5, including beef, tallow, (boiled) chicken, bacon, stewed meat, waxy and soapy.

TABLE 5
References used for each descriptor and
for training the sensory panellists

| Descriptor | Reference |
|---|---|
| Beef | Australian Angus Beef mince (25 g), pan fried for |
| | 3.5 min |
| Tallow | Remaining oil (sunflower and canola blend) (2 g) |
| | from pan frying beef |
| (Boiled) Chicken | Knorr Chicken stock cubes No added MSG (10 |
| | mg/mL) |
| Bacon | (Pork) Streaky Bacon, pan fried until slightly brown |
| Stewed meat | Heated control (Maillard mixture with coconut oil) |
| Waxy | Linoleic acid |
| Soapy | Oleic acid |

The panellists were then presented with the three samples in random order to prevent bias and tasked to rate the samples on the intensities of the selected attributes on a sliding scale from 0 to 10. In this scale, 0 represented the absence of that attribute in the sample, while 5 indicated that the intensity was the same as the reference provided and 10 meant that the aroma was extremely intense. The panellists were also asked to note down any other attributes out of the given list if perceived.

Heme Iron Samples produced more intense beefy, oily and fatty notes than Inorganic Iron and Control samples, as shown in FIG. 4. Inorganic Iron was able to increase the beefy aroma, albeit to a smaller extent than Heme Iron.

The Control sample was perceivably different from the other two samples, with overall less tallow, beef, bacon and fatty notes.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A heme composition, comprising:
a) heme at about 0.05% w/w to about 1% w/w relative to the heme composition; and
b) an antioxidant at about 0.25% w/w to about 5% w/w relative to the heme composition;
wherein the heme is derived from protoporphyrin IX extracted from a plant, algal, bacterial and/or animal source.

2. The heme composition according to claim 1, wherein the plant, algal, bacterial and/or animal source is selected from photosynthetic plant, photosynthetic algae, non-photosynthetic algae, cyanobacteria containing chlorophyll, animal blood, eggshell which is derived from eggs of Gallus gallus domesticus (Chicken), Anas platyrhynchos domesticus (Duck), Coturnix genus (Quail), or a combination thereof.

3. The heme composition according to claim 1, wherein the antioxidant is selected from DL-α-tocopherol, butylated hydroxyanisole (BHA), butylated hydroxytoluene, propyl gallate, trihydroxybutyrophenon (THBP), nordihydroguaiaretic acid, t-butylhydroquinone (TBHQ), dilauryl thiodiopropionate, ascorbic acid, sodium ascorbate, potassium ascorbate, erythorbic acid, ascorbyl palmitate, ascorbyl acetal, or a combination thereof.

4. The heme composition according to claim 1, wherein the heme composition further comprises an amino acid at about 2% w/w to about 40% w/w relative to the heme composition, wherein the amino acid is selected from D-amino acid, L-amino acid, DL-amino acid or their respective dipeptide, tripeptide, oligopeptide and polypeptide thereof.

5. (canceled)

6. The heme composition according to claim 1, wherein the heme composition further comprises a flavour enhancer at about 2% w/w to about 45% w/w relative to the heme composition, wherein the flavour enhancer is selected from animal-based and plant-based lipids such as short (5 carbon atoms or less), medium (6 to 12 carbon atoms), long (13 to 21 carbon atoms) and very long-chained (22 carbon atoms or more) saturated and/or unsaturated fatty acids either in their free fatty acid forms and/or contained within a triglyceride or phospholipid molecule, nucleoside, nucleotide, vitamin, protein hydrolysate from animal, plant, fungal, bacterial and/or in vitro origin, lecithin, or a combination thereof.

7. (canceled)

8. The heme composition according to claim 1, wherein the heme composition further comprises a sugar at about 1% w/w to about 20% w/w relative to the heme composition and/or sodium chloride at about 0.5% w/w to about 15% w/w relative to the heme composition.

9. The heme composition according to claim 1, wherein the heme composition further comprises a solvent, the solvent comprising:
a) water at about 40% w/w to about 60% w/w relative to solvent;
b) oil at about 17.5% w/w to about 35% w/w relative to solvent; and
c) a humectant at about 5% w/w to about 25% w/w relative to solvent;
wherein the oil is selected from coconut oil, algal oil, corn oil, soybean oil, palm fruit oil, palm kernel oil, safflower oil, flaxseed oil, rice bran oil, cottonseed oil, sunflower oil, canola oil, olive oil, or a combination thereof;
wherein the humectant is selected from lactic acid, acetic acid, glycerol, or a combination thereof;
wherein the solvent further comprises pH modulator at about 0.75% w/w to about 3% w/w relative to solvent, wherein the pH modulator is selected from acids such as hydrochloric acid, hydrobromic acid, hydroiodic acid, glacial acetic acid or formic acid, or a combination thereof, or bases such as hydroxides, carbonates and bicarbonates of lithium, sodium, potassium, and ammonium, or a combination thereof.

10-12. (canceled)

13. The heme composition according to claim 1, wherein the heme composition is characterised by a presence of hemin, hematin, Protoporphyrinogen IX, Coporphyrinogen III, Uroporphyrinogen III, Coporphyrin, Uroporphyrin, pentacarboxylic porphyrin, or a combination thereof.

14. The heme composition according to claim 1, wherein the heme composition is a biphasic mixture, oil-in-water or water-in-oil emulsified liquid system, semi-solid gel, suspension, monophasic liquid or solid.

15. The heme composition according to claim 1, wherein the heme comprises protoporphyrin IX and an iron salt, wherein the heme is generated when heat is applied to the heme composition.

16. A heme food product, comprising:
a) heme composition according to claim 1 at about 9% w/w to about 11% w/w relative to the heme food product; and
b) an alternative protein at about 15% w/w to about 40% w/w relative to the heme food product;
wherein heme is about 0.002% w/w to about 0.05% w/w relative to the heme food product.

17. The heme food product according to claim 16, wherein the alternative protein is derived from a source selected from plant, insect, fungus, bacteria, in vitro cultured animal cells, or a combination thereof.

18. The heme food product according to claim 16, wherein the plant source is selected from soy, pea, wheat, lentil, lupin, vetch, chickpea, cowpea, pigeon pea, adzuki bean, bambara bean, black bean, fava bean, kidney bean, lima bean, long bean, mung bean, navy bean, tepary bean, velvet bean, yam bean, oat, rice, quinoa, buckwheat, amaranth, camelina seed, hemp seed, pumpkin seed, rapeseed, sunflower seed, peanut, cashew nut, potato, jackfruit, duckweed, sweet potato, tapioca or a combination thereof, wherein the fungus source is selected from Aspergillus spp., Agrocybe spp. (Poplar mushrooms), Fusarium spp. (Microfungus), Komagataella spp., Rhizopus spp., Saccharomyces spp., Zygosaccharomyces spp., Agaricus bisporus (button mushroom), Flammulina filiformis (enokitake), Grifola frondosa (maitake), Lentinula edodes (shiitake), Lyophyllum shimeji (hon-shimeji), Morchella spp. (morels), Pleurotus spp. (oyster mushrooms), Volvariella volvacea (straw mushroom), or a combination thereof, and wherein the insect source is selected from the Insecta Class.

19. The heme food product according to claim 16, wherein the heme food product further comprises at least one of the following:
a) a vegetable oil at about 5% w/w to about 15% w/w relative to the heme food product;
b) a food flavouring at about 2.5% w/w to about 25% w/w relative to the heme food product;
c) a stabiliser at about 1% w/w to about 4% w/w relative to the heme food product; and
d) a food colouring at about 0.035% w/w to about 0.5% w/w relative to the heme food product.

20. A method of synthesising heme, comprising:
a) extracting crude protoporphyrin IX from a plant, algal, bacterial and/or animal source using an extraction solvent;
b) purifying the crude protoporphyrin IX in order to form purified protoporphyrin IX;
c) metalating the purified protoporphyrin IX with an iron salt, base and under inert conditions in order to form heme;
wherein the extraction solvent is a mixture of an acid and an organic solvent;
wherein the acid in the extraction solvent is an inorganic acid, organic acid, or a combination thereof;
wherein the organic solvent in the extraction solvent is a polar solvent selected from acetone, methanol, ethanol, isopropanol, ethyl acetate, propyl acetate, butyl acetate, alkyl ester, or a combination thereof;
wherein the iron salt is selected from iron(II) chloride, iron(III) chloride, iron(II) bromide, iron(Ill) bromide, iron(II) iodide, iron(Ill) iodide, iron(II) sulphate, iron(Ill) sulphate, iron(II) nitrate, iron(III) nitrate, iron(II) fumarate, iron(III) fumarate, iron(II) gluconate, iron(Ill) gluconate, their hydrates thereof, or a combination thereof;
wherein the base is selected from metal hydroxide, metal bicarbonate, metal carbonate, metal oxide, or a combination thereof and wherein the metal is selected from sodium, potassium, magnesium, calcium, or a combination thereof;
wherein the inert condition is inert gas selected from helium, argon, nitrogen, carbon dioxide, or a combination thereof.

21. The method according to claim 20, wherein the plant, algal, bacterial and/or animal source is eggshell.

22-23. (canceled)

24. The method according to claim 20, wherein the extraction step further comprises at least one of the following:
a) stirring the plant and/or animal source in the extraction solvent at about 15° C. to about 60° C.;
b) stirring the plant and/or animal source in the extraction solvent at about 600 mmHg to about 900 mmHg;
c) filtering the plant and/or animal source in the extraction solvent in order to obtain the crude protoporphyrin IX in a filtrate; and
d) basifying the filtrate with a base in order to precipitate the crude protoporphyrin IX as a solid;
wherein the base is an inorganic base selected from lithium hydroxide, sodium hydroxide, potassium hydroxide, ammonium hydroxide, or a combination thereof.

25. (canceled)

26. The method according to claim 20, wherein the purification step comprises the dissolving the crude protoporphyrin IX in a polar solvent, filtering the crude protoporphyrin IX in the polar solvent in order to obtain a filtrate and removing the polar solvent from the filtrate, wherein the polar solvent is selected from dimethyl sulfoxide, N,N-dimethylformamide, or a combination thereof.

27-28. (canceled)

29. The method according to claim 20, wherein the metalation step is performed in the presence of a solvent selected from formic acid, acetic acid, acetone, ethanol, dimethyl sulfoxide, N,N-dimethylformamide, or a combination thereof;
wherein the metalation step is performed at a temperature at about 50° C. to about 190° C. for about 4 h to about 24 h.

30-31. (canceled)

32. The method according to claim 20, wherein the metalation step further comprises acidifying the heme in order to precipitate heme as a solid, wherein the acid is selected from hydrochloric acid, hydrobromic acid, hydroiodic acid, sulphuric acid, nitric acid, or a combination thereof.
